(19) United States
(12) Patent Application Publication
(10) Pub. No.: US 2009/0206069 A1
(43) Pub. Date: Aug. 20, 2009

(54) Heating element systems

(75) Inventor: Scott M. Hamel, Wilton, NH (US)

Correspondence Address: EDWARDS ANGELL PALMER & DODGE LLP, P.O. BOX 55874, BOSTON, MA, 02205, US

(73) Assignee: Saint-Gobain Ceramics & Plastics, Inc., Worcester, MA (US)

(21) Appl. No.: 12/284,724

(22) Filed: Sep. 23, 2008

Related U.S. Application Data
(60) Provisional application No. 60/995,017, filed on Sep. 23, 2007.

(51) Int. Cl. F23Q 7/22; H05B 3/18

(52) U.S. Cl. 219/270; 219/544; 29/611

(57) ABSTRACT

New heating systems are provided that include a mating block element that reliably encases a resistive igniter element. Preferred igniter systems can prevent undesired moisture and other materials from contacting electrical lead portions of the igniter element.

The present application claims the benefit of U.S. provisional application No. 60/995,017, filed Sep. 23, 2007, which is incorporated herein by reference in its entirety.

### 1. FIELD

The invention relates generally to heating element systems and, more particularly, to ceramic igniters that contain improved sealing for electrical contact portions of the device.

### 2. BACKGROUND

Ceramic igniters have found increased use in certain ignition applications such as gas fired furnaces, stoves and clothes dryers. See, generally, U.S. Pat. Nos. 3,875,477, 3,928,910, 3,974,106, 4,260,872, 4,634,837, 4,804,823, 4,912,305, 5,085,237, 5,191,508, 5,233,166, 5,378,956, 5,405,237, 5,543,180, 5,785,911, 5,786,565, 5,801,361, 5,820,789, 5,892,201, 6,028,292, and U.S. Pat. No. 6,078,028.

While ceramic igniter designs and performance have improved, problems still exist that can prevent optimal functioning. One persistent problem is penetration of moisture or other fluids into the igniter electrical lead or contact portion, i.e. where electrical contacts mate with the igniter element, typically via a lead frame.

Penetrating fluids can originate from a variety of sources, including moisture from the surrounding area and the ambient atmosphere as well as liquid fuels such as kerosene that the ceramic element ignites.

Cooking environments are especially problematic. Ceramic igniters used in gas stove settings frequently come into contact with spilled or splashed fluids (e.g. liquids, steam, etc.) emanating from pots or other apparatus on the stove.

It thus would be desirable to have new ceramic igniters that could provide enhanced performance properties. It would be particularly desirable to have new ceramic igniters that have enhanced resistance to undesired fluid penetration and/or oxidation of the igniter's electrical contact portion.

### SUMMARY

We now provide new heating elements that can exhibit significantly enhanced resistance to undesired moisture penetration.

In one aspect, new igniter systems are provided that include a mating block element that reliably encases a resistive igniter element. Preferred igniter systems can prevent undesired moisture and other materials from contacting electrical lead portions of the igniter element. Ceramic resistive igniter elements are preferred for many applications.

In one preferred aspect, igniter systems are provided that contain a single electrical lead. Such single-lead systems suitably comprise a block element that can serve as an electrical ground, e.g. where at least a portion of the block element is comprised of a non-conductor such as a ceramic or polymeric material.

In preferred systems, igniter and block elements mate to provide reliable, desired positioning of the elements, e.g. where the height and angle of the igniter element is fixed as desired with respect to the igniter element by virtue of the mating of the elements. Such reliable mating and positioning of the elements can provide consistent ignition performance of the system.

In particular aspects, the resistive igniter element is configured to engage the block element. For instance, the resistive igniter element may contain one or more grooves or flanges that will mate with corresponding feature of the block element, or other attachment may be utilized e.g. a threaded or press-fit engagement may be suitably employed.

In preferred embodiments, the encasing block element and resistive igniter element are separate, distinct parts, e.g. the block and igniter elements may be mated through brazing or attachment. In other embodiments, however, the block and igniter elements may be a single integral part, i.e. the elements are not separated during normal use. For instance, the block and igniter elements may be fabricated from ceramic materials in a batch or injection molding process.

The block element may be fabricated from a variety of materials including e.g. sintered ceramic, metal, and the like, or both metal and ceramics. Block elements that are composed at least in part of a sintered ceramic may be preferred for certain applications, such as a single-lead design as disclosed herein.

Methods are also provided for manufacture of igniter systems of the invention, which may include adjoining the igniter and block elements in a releasable fit engagement. Such methods also may include forming an igniter system where igniter and block elements are integrally formed (e.g. single ceramic element).

Particularly preferred methods for producing igniter systems of the invention include a single step attachment of lead frame and block elements to an igniter element. More specifically, such methods may include (a) providing an assembly comprising a lead frame element associated with a ceramic igniter element and a block element encasing the igniter element; and (b) thermally treating the assembly to affix the lead frame and block elements to the igniter element. The thermal treatment may fuse the lead frame and block elements to the igniter element through a braze material, preferably where a single thermal treatment or cycle fuses both the lead frame element and the block element to the igniter element.

The invention further includes heating systems that may comprise a heating appliance (e.g. gas-burning cook top stove) that includes a present igniter system positioned in the appliance to ignite fuel. For certain applications, preferably the igniter system is positioned within the appliance where the appliance serves to ground the igniter and a single-lead igniter system can be employed.

Igniter systems of the invention will have significant utility in a large number of applications. In particular, igniters of the invention will be especially useful in environments where fluid is frequently present, e.g. cooking environments such as to ignite a cook top gas burner where regular exposure to fluids can occur.

More specifically, in cooking environments, the block element can shield the igniter element, including electrical contact portions thereof from fluid spills that can cause electrical shorting or other degradation or failure of the igniter system.

Other aspects of the invention are disclosed infra.

### BRIEF DESCRIPTION OF THE DRAWINGS

FIG. 1 shows in partial phantom view an igniter system of the invention;

FIG. 2 shows a preferred block element;

FIG. 3 shows a further preferred igniter system of the invention;

FIG. 4 shows a view along line 4A-4A of FIG. 3;

FIGS. 5A and 5B shows a preferred single lead igniter system (block element in phantom view);

FIG. 6 depicts a preferred double lead igniter system of the invention (block element in phantom view); and

FIG. 7 shows a igniter system nested within a heating appliance.

### DETAILED DESCRIPTION

As discussed above, we now provide ceramic igniter systems that comprise associated igniter and block elements and can exhibit significantly enhanced resistance to undesired moisture or other environmental infiltration.

Igniter systems of the invention suitably may be of a variety of configurations, including e.g., substantially rectangular or substantially cylindrical (rod-shaped), including cylindrical with varying cross-sectional dimensions such as a tapered or narrowing tip portion.

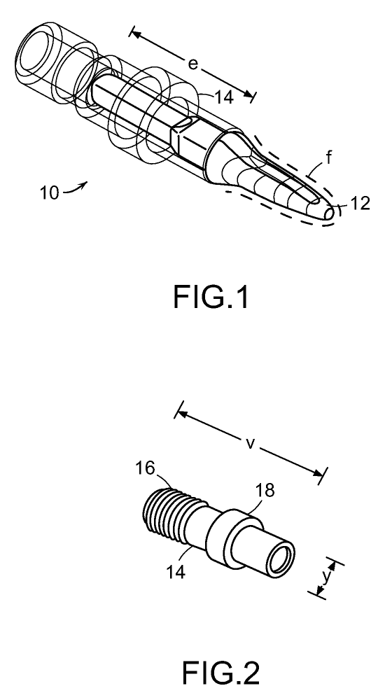

Referring now to the drawings, FIG. 1a preferred igniter system 10 which includes igniter element 12 encased with block element 14 (block element shown in phantom view).

As discussed above, elements 12 and 14 preferably are securely nested whereby block element 14 can effectively protect igniter 12 from degradation during use, including to seal igniter element from undesired moisture infiltration.

In certain preferred systems, the igniter system 10 does not include any type of sealant material to affix the igniter element 12 and block element 14, such as an epoxy or potting system as used in prior systems, or a hermetic sealant such as a ceramoplastic material (e.g. glass/mica) as disclosed in U.S. Pat. No. 6,933,471 to Hamel et al. That is, the igniter and block elements can securely mate and protect the igniter element including electrical lead portions thereof through a press fit, mating flanges including threaded engagement, or other engagement, that do not necessitate use of additional attachment materials (such as epoxy or hermetic sealants).

In other embodiments, an epoxy or hermetic or other additional attachment material may be employed if desired to further secure igniter and block elements, although as discussed such an additional material is not needed to secure preferred systems.

FIG. 2 depicts a preferred block element 14 which includes an outward threaded engagement 16 which can secure an igniter system within a larger system such as a cooking or heating appliance, including for instance a stove-top gas burner. Preferred block element 14 also includes a further shielding portion 18 which can further aid to protect an encased igniter element including electrical connection portions thereof.

As discussed, block element 14 can be fabricated from a variety of materials including a metal such as stainless steel, aluminum or various alloys, or a sintered ceramic, or a metal/ceramic composite structure. For instance, block element 14 may have a metal core or frame structure that is coated with an insulating sintered ceramic. In a preferred design, a block element may have a metal first (lower or proximal) portion and a sintered ceramic upper (or distal) portion, e.g. where the ceramic upper portion is electrically insulating (heat sink).

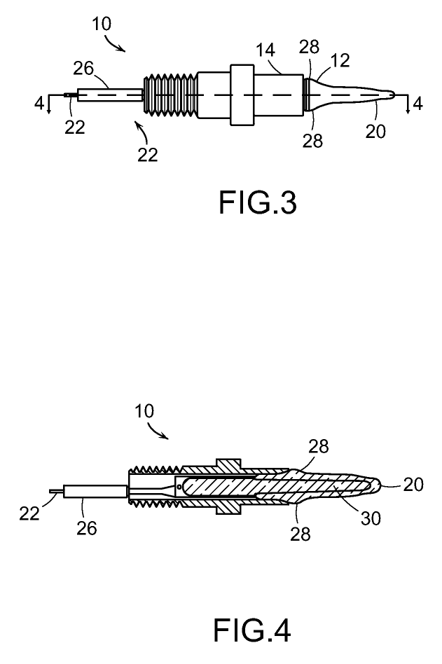

FIG. 3 shows igniter system 10 with mated igniter element 12 and block element 14. Igniter tapered tip ignition region (or “hot zone”) 20 provides resistive heating and ignition of liquid or gaseous fuel during use of system 10. To provide resistive heating, power may be supplied to system 10 via electrical lead 22 shown at igniter element proximal end 24 feed through lead frame element 26. Lead 22 communicates to ceramic conductive zones 28 that form an electrical pathway with igniter hot zone 20. As discussed above, preferred block element 14 includes both threaded engagement 16 and flange 18 that can serve to securely nest the igniter system 10 within a larger ignition environment such as a gas stove cook top or other cooking or heating appliance.

FIG. 4 depicts igniter system 10 in a cut-away view with block element 14 encasing igniter element 12. Element 12 includes hot zone 20 which is in communication with conductive zones 28 and insulator or heat sink region 30. In use, power is provided to the igniter via lead 22 which feeds through lead frame element 26. In the exemplary systems of FIGS. 3 and 4, igniter 12 and block 14 elements are releasably secured through mating flanges and grooves of the respective elements.

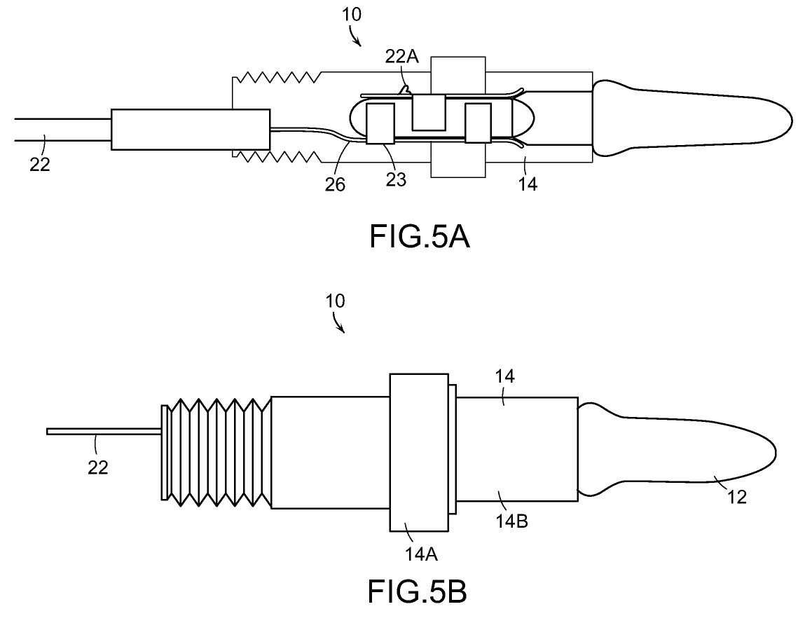

FIGS. 5A and 5B shows a shows a preferred single lead igniter system 10 of the invention where igniter element 12 is affixed to block element 14 and lead frame element 26. Preferred lead frames and attachment thereof to igniter elements are disclosed in U.S. Pat. No. 7,241,975 to Hamel et al. Single electrical lead 22 adjoins a conductive region of the igniter element 10 such as through brazing at juncture 23 shown in FIG. 5A. Block 14 preferably has a metal construction lower or proximal portion 14A and ceramic or other insulator upper or distal portion 14B as shown in FIG. 5B. That non-conductor upper portion 14B can mate with housing into which the igniter system is mounted for use (e.g. gas cook top) and provide an electrical ground for the igniter system. As referred to herein, a proximal end of a block element or other feature of an igniter system is the portion that is relatively closer to the end of an igniter element that mates with an electrical lead, and a distal end of a block element or other feature of an igniter system is the portion that is relatively closer to the end of an igniter element that contains the hot or ignition region.

Suitable braze materials to affix an electrical lead to an igniter element, or a lead frame to an igniter or block element, are commercially available as well as disclosed in U.S. Pat. No. 7,241,975 to Hamel et al. A silver paste material can be preferred for many applications.

As depicted in FIG. 5A, protruding conductive element 22A can mate and extend into block element 14 and thereby form an electrical ground of the circuit formed with the igniter element and enable use of a single electrical lead, as discussed herein.

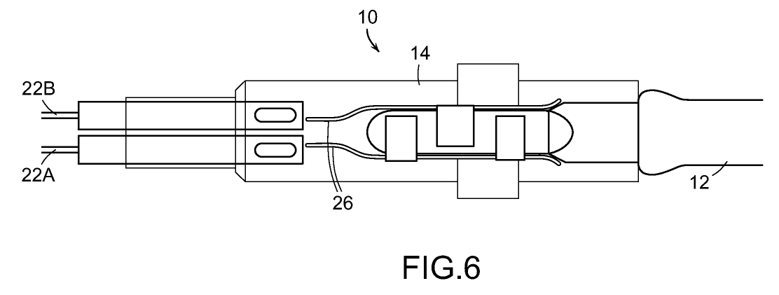

FIG. 6 depicts a preferred multiple lead igniter system 10 which includes igniter element 12 with mating block element 14 (shown in phantom view) and lead frame element 26. First electrical lead 22A provides power to system 10 and second electrical lead 22B can complete the electrical circuit.

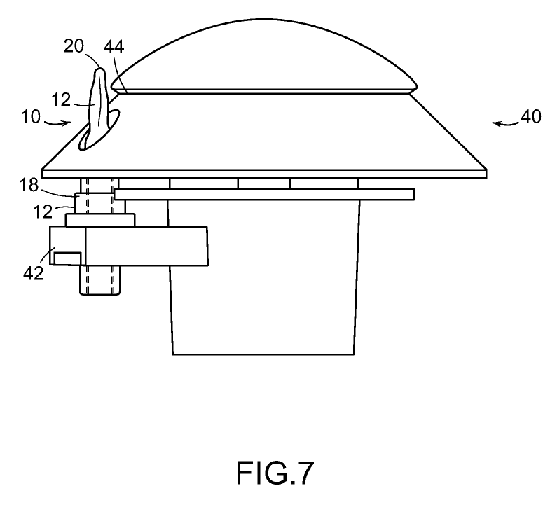

FIG. 7 shows heating appliance 40 (specifically a gas-burning cook top unit) which includes igniter system 10 with igniter element 12 and block element 14 (block element is shown in phantom view). Igniter system 10 is nested within appliance mounting arm 42 whereby igniter resistive (hot or ignition) zone 20 is proximate to gas fuel ports 44 and can thereby ignite gas fuel during use of igniter system 10. As can be seen in FIG. 7, block element encasing nesting flange 18 positions the block element (and hence igniter system) in the mounting arm 42. Block element 14 also can mate with heating appliance 40 as such as via mounting arm 42 to provide an electrical ground to the igniter element system.

For at least certain applications, rod-shaped or cylindrical-shaped resistive sintered igniter elements may be preferred such as elements produced by injection molding as described in U.S. Patent Publication 2006/0213897.

The composition of the hot zone 20, conductive zones 28 and insulator regions 30 of igniter elements of the invention may suitably vary; however, suitable compositions for those regions are disclosed in U.S. Pat. No. 5,786,565 to Willkens et al. as well as in U.S. Pat. No. 5,191,508 to Axelson et al.

More particularly, the composition of the hot zone should be such that the hot zone exhibits a high temperature (i.e. 1350° C.) resistivity of between about 0.01 ohm-cm and about 3.0 ohm-cm, and a room temperature resistivity of between about 0.01 ohm-cm and about 3 ohm-cm.

A preferred hot zone contains a sintered composition of an electrically insulating material, a metallic conductor, and, in an optional yet preferred embodiment, a semiconductor material as well. As used herein, the term “electrically insulating material” or variations thereof refer to a material having a room temperature resistivity of at least about 10¹⁰ ohm-cm, while the terms “metallic conductor,” “conductive material” and variations thereof signify a material that has a room temperature resistivity of less than about 10⁻² ohm-cm, and the terms “semiconductive ceramic,” “semiconductor material” or variations thereof denote a material having a room temperature resistivity of between about 10 and 10⁸ ohm-cm.

In general, an exemplary composition for a hot zone of the ceramic igniter element includes (a) between about 50 and about 80 volume percent (vol % or v/o) of an electrically insulating material having a resistivity of at least about 10¹⁰ ohm-cm; (b) between about 5 and about 45 v/o of a semiconductive material having a resistivity of between about 10 and about 10⁸ ohm-cm; and (c) between about 5 and about 25 v/o of a metallic conductor having a resistivity of less than about 10⁻² ohm-cm.

Preferably, the hot zone comprises 50-70 v/o of the electrically insulating material, 10-45 v/o of the semiconductive ceramic, and 6-16 v/o of the conductive material.

Typically, the metallic conductor is selected from the group consisting of molybdenum disilicide, tungsten disilicide, and nitrides such as titanium nitride, and carbides such as titanium carbide, with molybdenum disilicide being a generally preferred metallic conductor. In certain preferred embodiments, the conductive material is MoSi₂, which is present in an amount of from about 9 to 15 vol % of the overall composition of the hot zone, more preferably from about 9 to 13 vol % of the overall composition of the hot zone.

Generally preferred semiconductor materials, when included as part of the overall composition of the hot 12 and cold zones 14a, 14b of the igniter 10, include, but are not limited to, carbides, particularly silicon carbide (doped and undoped), and boron carbide. Silicon carbide is a generally preferred semiconductor material for use in the ceramic igniter 10.

Suitable electrically insulating material components of hot zone compositions include, but are not limited to, one or more metal oxides such as aluminum oxide, a nitride such as a aluminum nitride, silicon nitride or boron nitride; a rare earth oxide (e.g., yttria); or a rare earth oxynitride. Aluminum nitride (AlN) and aluminum oxide (Al₂O₃) are generally preferred.

Particularly preferred hot zone compositions of the invention contain aluminum oxide and/or aluminum nitride, molybdenum disilicide, and silicon carbide. In at least certain embodiments, the molybdenum disilicide is preferably present in an amount of from 9 to 12 vol %.

As discussed above, igniters elements of the invention typically also contain at least one or more low resistivity conductive regions in electrical connection with the hot zone to allow for attachment of wire leads to the igniter. Typically, a hot zone is disposed between two cold or conductive zones which are generally comprised of, e.g., AlN and/or Al₂O₃ or other insulating material; SiC or other semiconductor material; and MoSi₂ or other conductive material.

Preferably, cold or conductive regions will have a significantly higher percentage of the conductive and/or semiconductive materials (e.g., SiC and MoSi₂) than are present the hot zone. Accordingly, cold or conductive regions typically have only about ⅕ to 1/1000 of the resistivity of a mating hot zone region, and do not rise in temperature to the levels of the hot zone. More preferred is where the cold or conductive zone room temperature resistivity is from 5 to 20 percent of the room temperature resistivity of the mating hot zone.

A preferred cold zone composition for use in an igniter element of the invention comprises about 15 to 65 v/o of aluminum oxide, aluminum nitride or other insulator material, and about 20 to 70 v/o MoSi₂ and SiC or other conductive and semiconductive material in a volume ratio of from about 1:1 to about 1:3. More preferably, the cold or conductive zones comprise about 15 to 50 v/o of aluminum oxide and/or aluminum nitride, about 15 to 30 v/o SiC, and about 30 to 70 v/o MoSi₂. For ease of manufacture, the cold zone composition is preferably formed of the same materials as the hot zone composition, but with the relative amounts of semiconductive and conductive materials being greater in the cold zone(s) than the hot zone(s).

If included in an igniter element, the electrically insulating heat sink region is suitably comprised of a composition that provides sufficient thermal mass to mitigate convective cooling of the hot zone. Suitable ceramic compositions for a heat sink regions include compositions comprising at least about 90 vol % of at least one of aluminum nitride, boron nitride, silicon nitride, alumina and mixtures thereof. Where a hot zone composition of AlN—MoSi₂—SiC is employed, a heat sink material comprising at least 90 vol % aluminum nitride and up to 10 vol % alumina can be preferred for compatible thermal expansion and densification characteristics.

Ceramic igniter systems of the invention can be employed with a variety of voltages, including, but not limited to, nominal voltages of 6, 8, 12, 24, 120, 220, 230 or 240 volts. Preferred igniters of the invention can heat rapidly from room temperature to operational temperatures, e.g. to about 1350° C. in about 4 seconds or less, even 3 seconds or less, or even 2.75 or 2.5 second or less.

Preferred igniters systems of the invention also can provide a stable ignition temperature with a hot zone power density (surface loading) of from 60 to 200 watts per cm² of the hot zone region.

The processing of the ceramic component (i.e., green body processing and sintering conditions) and the preparation of the igniter from the densified ceramic can be done by conventional methods. Typically, such methods are carried-out in substantial accordance with U.S. Pat. No. 5,786,565 to Willkens et al. and U.S. Pat. No. 5,191,508 to Axelson et al., the disclosures of which are explicitly incorporated by reference herein.

Dimensions of igniters of the invention may vary widely and may be selected based on intended use of the igniter. For instance, the length of a preferred igniter (length e in FIG. 1) suitably may be from about 0.5 to about 5 cm, more preferably from about 1 about 3 cm, and the igniter maximum cross-sectional width may suitably be from about suitably may be from about 0.2 to about 3 cm.

Similarly, the lengths of the conductive and hot zone regions also may suitably vary. Preferably, the length of a first conductive zone of an igniter of the configuration depicted in FIG. 1 may be from 0.2 cm to 2, 3, 4, or 5 more cm. More typical lengths of the first conductive zone will be from about 0.5 to about 5 cm. The total hot zone electrical path length (length f in FIG. 1) suitably may be about 0.2 to 5 or more cm.

In preferred systems, the hot or resistive zone of an igniter of the invention will heat to a maximum temperature of less than about 1450° C. at nominal voltage; and a maximum temperature of less than about 1550° C. at high-end line voltages that are about 110 percent of nominal voltage; and a maximum temperature of less than about 1350° C. at low-end line voltages that are about 85 percent of nominal voltage.

Block elements also may have varying dimensions and should be coordinated with the dimensions of an associated igniter element. For instance, the length of a preferred block element (length v in FIG. 2) suitably may be from about 0.5 to about 4 cm, more preferably from about 1 about 3 cm, and the block element cross-sectional width may suitably be from about (length y in FIG. 2) suitably may be from about 0.2 to about 3 cm.

Igniters can be produced in accordance with generally known procedures, such as disclosed in U.S. Pat. No. 5,405,237 to Washburn. See also Example 1 which follows, for illustrative conditions. As discussed above, rod-shaped or cylindrical-shaped igniter elements are preferred for many applications, including those elements produced by injection molding. See U.S. Patent Publication 2006/0213897 to Annavarapu et al. See also Example 2 which follows, for illustrative procedures for producing an injection molded ceramic igniter element.

More specifically, in one manufacturing method, a formed billet of green body igniters can be subjected to a first warm press (e.g. less than 1500° C. such as 1300° C.), followed by a second high temperature sintering (e.g. 1800° C. or 1850° C.). The first warm sintering provides a densification of about 65 or 70% relative to theoretical density, and the second higher temperature sintering provides a final densification of greater than 99% relative to theoretical density.

In preferred igniter production methods a billet sheet is provided that comprises a plurality of affixed or physically attached “latent” igniter elements. The billet sheet has hot and cold zone compositions that are in a green state (not densified to greater than about 96% or 98% theoretical density), but preferably have been sintered to greater than about 40% or 50% theoretical density and suitably up to 90 ort 95% theoretical density, more preferably up to about 60 to 70% theoretical density. Such a partial densification is suitably achieved by a warm press treatment, e.g. less than 1500° C. such as 1300° C., for about 1 hour under pressure such as 3000 psi and under argon atmosphere.

It has been found that if the hot and cold zones compositions are densified at greater than 75 or 80 percent of theoretical density, the billet will be difficult to cut in subsequent processing steps. Additionally, if the hot and cold zones compositions are densified at less than about 50 percent, the compositions often degrade during subsequent processing. The hot zone portion extends across a portion of the thickness of the billet, with the balance being the cold zone.

The billet may be of a relatively wide variety of shapes and dimensions. Preferably, the billet is suitably substantially square, e.g. a 9 inch by 9 inch square, or other suitable dimensions or shapes such as rectangular, etc. The billet is then preferably cut into portions such as with a diamond cutting tool. Preferably those portions have substantially equal dimensions. For instance, with a 9 inch by 9 inch billet, preferably the billet is cut into thirds, where each of the resulting sections is 9 inches by 3 inches.

The billet is then further cut (suitably with a diamond cutting tool) to provide individual igniters. A first cut will be through the billet, to provide physical separation of one igniter element from an adjacent element. Alternating cuts will not be through the length of the billet material, to enable insertion of the insulating zone (heat sink) into each igniter. Each of the cuts (both through cuts and non-through cuts) may be spaced e.g. by about 0.2 inches.

After insertion of the heat sink zone, the igniters then can be further densified, preferably to greater than 99% of theoretical density. Such further sintering is preferably conducted at high temperatures, e.g. at or slightly above 1800° C., under a hot isostatic press.

The several cuts made into the billet can be suitably accomplished in an automated process, where the billet is positioned and cut by a cutting tool by an automated system, e.g. under computer control.

Once densified, electrical contacts are suitably applied to the cold region end of the igniter element, distal to hot zone regions, as generally depicted in FIGS. 3 and 4. The electrical contacts may be affixed to the igniter element by e.g. an adhesive. A lead frame is generally attached to each contact to enable communication with a power source as illustrated in FIGS. 3, 4 and 5.

Thereafter, a block element may be engaged with the igniter element as discussed above. Lead frame integration is generally preferred. For example, in one preferred production method, an assembly comprising a lead frame element associated with a ceramic igniter element and a block element encasing the igniter element is provided. The assembly can be thermally treated to affix such as through brazing the igniter element to the lead frame and block elements.

As discussed, preferred igniter system assembly methods include a single step attachment of lead frame and block elements to an igniter elements. More specifically, such methods may include (a) providing an assembly comprising a lead frame element associated with a ceramic igniter element and a block element encasing the igniter element; and (b) thermally treating the assembly to affix the lead frame and block elements to the igniter element, wherein the thermal treatment may fuse the lead frame and block elements to the igniter element through a braze material in a single (e.g., no intervening cooling of more than 400° C.) thermal cycle fuses.

In a suitable injection molding fabrication method, an integral igniter element having regions of differing resistivities (e.g., conductive region(s), insulator or heat sink region and higher resistive “hot” zone(s)) may be formed by sequential injection molding of ceramic or pre-ceramic materials having differing resistivities.

Thus, for instance, a base element may be formed by injection introduction of a ceramic material having a first resistivity (e.g. ceramic material that can function as an insulator or heat sink region) into a mold element that defines a desired base shape such as a rod shape. The base element may be removed from such first mold and positioned in a second, distinct mold element and ceramic material having differing resistivity—e.g. a conductive ceramic material—can be injected into the second mold to provide conductive region(s) of the igniter element. In similar fashion, the base element may be removed from such second mold and positioned in a yet third, distinct mold element and ceramic material having differing resistivity—e.g. a resistive hot zone ceramic material—can be injected into the third mold to provide resistive hot or ignition region(s) of the igniter element.

Alternatively, rather than such use of a plurality of distinct mold elements, ceramic materials of differing resistivitities may be sequentially advanced or injected into the same mold element. For instance, a predetermined volume of a first ceramic material (e.g. ceramic material that can function as an insulator or heat sink region) may be introduced into a mold element that defines a desired base shape and thereafter a second ceramic material of differing resistivity may be applied to the formed base.

Ceramic material may be advanced (injected) into a mold element as a fluid formulation that comprises one or more ceramic materials such as one or more ceramic powders.

For instance, a slurry or paste-like composition of ceramic powders may be prepared, such as a paste provided by admixing one or more ceramic powders with an aqueous solution or an aqueous solution that contains one or more miscible organic solvents such as alcohols and the like. A preferred ceramic slurry composition for extrusion may be prepared by admixing one or more ceramic powders such as MoSi₂, SiC, Al₂O₃, and/or AlN in a fluid composition of water optionally together with one or more organic solvents such as one or more aqueous-miscible organic solvents such as a cellulose ether solvent, an alcohol, and the like. The ceramic slurry also may contain other materials e.g. one or more organic plasticizer compounds optionally together with one or more polymeric binders.

A wide variety of shape-forming or inducing elements may be employed to form an igniter element, with the element of a configuration corresponding to desired shape of the formed igniter. For instance, to form a rod-shaped element, a ceramic powder paste may be injected into a cylindrical die element. To form a stilt-like or rectangular-shaped igniter element, a rectangular die may be employed. After advancing ceramic material(s) into a mold element, the defined ceramic part suitably may be dried e.g. in excess of 50° C. or 60° C. for a time sufficient to remove any solvent (aqueous and/or organic) carrier.

Example 2 which follows describes preferred injection molding processes to form an igniter element.

As indicated above, igniters of the invention may be used in many applications, including gas phase fuel ignition applications such as furnaces and cooking appliances, baseboard heaters, boilers, and stove tops and indoor or outdoor gas grills.

Igniters of the invention also may be employed in other applications, including for use as a heating element in a variety of systems. More particularly, an igniter of the invention can be utilized as an infrared radiation source (i.e. the hot zone provides an infrared output) e.g. as a heating element such as in a furnace or as a glow plug, in a monitoring or detection device including spectrometer devices, and the like.

Preferred igniter systems of the invention are distinct from heating elements known as glow plugs. Among other things, frequently employed glow plugs often heat to relatively lower temperatures e.g. a maximum temperature of about 800° C., 900° C. or 1000° C. and thereby heat a volume of air rather than provide direct ignition of fuel, whereas preferred igniters of the invention can provide maximum higher temperatures such as at least about 1200° C., 1300° C. or 1400° C. to provide direct ignition of fuel. Preferred igniters of the invention also need not include gas-tight sealing around the element or at least a portion thereof to provide a gas combustion chamber, as typically employed with a glow plug system. Still further, many preferred igniters of the invention are useful at relatively high line voltages, e.g. a line voltage in excess of 24 volts, such as 60 volts or more or 120 volts or more including 220, 230 and 240 volts, whereas glow plugs are typically employed only at voltages of from 12 to 24 volts.

The following non-limiting examples are illustrative of the invention. All documents mentioned herein are incorporated herein by reference in their entirety.

### Example 1

### Igniter Fabrication

An igniter element of the invention is suitably prepared as follows.

Hot zone and cold zone compositions were prepared for a first igniter. The hot zone composition comprised 70.8 volume % (based on total hot zone composition) AlN, 20 volume % (based on total hot zone composition) SiC, and 9.2 volume % (based on total hot zone composition) MoSi₂. The cold zone composition comprised 20 volume % (based on total cold zone composition) AlN, 20 volume % (based on total cold zone composition) SiC, and 60 volume % (based on total cold zone composition) MoSi₂. The cold zone composition was loaded into a hot die press die and the hot zone composition loaded on top of the cold zone composition in the same die. The combination of compositions was densified together under heat and pressure to provide the igniter.

### Example 2

### Additional Igniter Fabrication

Powders of a resistive composition (22 vol % MoSi₂, remainder Al₂O₃) and an insulating composition (5 vol % SiC, remainder Al₂O₃) were mixed with an organic bonder (about 6-8 wt % vegetable shortening, 2.4 wt % polystyrene and 2-4 wt % polyethylene) to form two pastes with about 62 vol % solids. The two pastes were loaded into two barrels of a co-injection molder. A first shot filled a half-cylinder shaped cavity with insulating paste forming the supporting base with a fin running along the length of the cylinder. The part was removed from the first cavity, placed in a second cavity and a second shot filled the volume bounded by the first shot and the cavity wall core with the conductive paste. The molded part which forms a hair-pin shaped conductor with insulator separating the two legs. The rod was then partially debindered at room temperature in an organic solvent dissolving out 10 wt % of the added 10-16 wt %. The part was then thermally debindered in flowing inert gas such as N₂ at 300-500° C. for 60 hours to remove the remainder of the residual binder. The debindered parts were densified to 95-97% of theoretical at 1800-1850° C. in Argon. Densified parts were cleaned up by grit-blasting. When the two legs of the igniters are connected to a power supply at voltages ranging from of 120V, the hot-zone attained at temperature of about 1307° C.

### Example 3

### Igniter System Fabrication

A single lead igniter system containing igniter and block elements as shown in FIGS. 5A and 5B is prepared as follows.

A rod-shaped integral igniter element is prepared as described in Example 2 above. The formed, sintered igniter element is then mounted in a stainless steel lead frame element with a silver braze foil as generally described in Example 2 of U.S. Pat. No. 7,241,975. The lead frame element is also depicted in FIGS. 5A and 5B.

A block element with exterior threads and comprised of both stainless steel and an upper sintered ceramic insulator composition as depicted in FIG. 5B is then mounted onto the lead frame/igniter element assembly. A silver braze is applied to igniter element regions that contact the block element. The assembled igniter system is then fused (braze reflow) by heating the igniter system at about 800° C. for 10 minutes in a vacuum oven at about 1×10⁻³ torr. That thermal treatment can provide braze reflow for both the sealing of the lead frame to the igniter element and the sealing of the igniter and block elements.

The invention has been described in detail with reference to particular embodiments thereof. However, it will be appreciated that those skilled in the art, upon consideration of this disclosure, may make modifications and improvements within the spirit and scope of the invention.

What is claimed is:

1. A ceramic igniter system comprising a ceramic igniter element and encasing block element that is affixed to and encases the igniter element.

2. The igniter system of claim 1 wherein the igniter element contains a single electrical lead.

3. The igniter system of claim 1 wherein the block element functions as an electrical ground.

4. The igniter system of claim 2 wherein the block element functions as an electrical ground.

5. The igniter system of claim 1 wherein the block element comprises ceramic portions.

6. The igniter system of claim 1 wherein the block element comprises metal and ceramic portions.

7. The igniter system of claim 1 wherein the block element proximal end is metal and the block element distal end comprises a ceramic portion.

8. The igniter system of claim 1 wherein the igniter and block elements are affixed without a potting cement or hermetic sealant.

9. The igniter system of claim 1 wherein the igniter and block element are configured for secure engagement of the elements.

10. The igniter system of claim 1 wherein the igniter and block elements are affixed by metal brazing.

11. A ceramic igniter system comprising:
a ceramic igniter element nested within a lead frame element;
a block element affixed to and encasing the igniter element.

12. The igniter system of claim 11 wherein the igniter element contains a single electrical lead.

13. The igniter system of claim 11 wherein the block element functions as an electrical ground.

14. The igniter system of claim 11 wherein the lead frame and block elements are both affixed by a metal braze to the igniter element.

15. A method for producing a ceramic igniter system comprising:
(a) providing an assembly comprising a lead frame element associated with a ceramic igniter element and a block element encasing the igniter element;
(b) thermally treating the assembly to affix the lead frame and block elements to the igniter element.

16. The method of claim 15 wherein the thermal treatment fuses the lead frame and block elements to the igniter element through a braze material.

17. The method of claim 15 wherein a single thermal treatment fuses both the lead frame element and the block element to the igniter element.

18. A heating system comprising:
a heating appliance comprising a igniter system of claim 1 positioned therein to ignite fuel.

19. The heating system of claim 18 wherein the appliance is a gas cook top or a gas grill.
